(19) United States
(12) Patent Application Publication
(10) Pub. No.: US 2007/0216505 A1
(43) Pub. Date: Sep. 20, 2007

(54) Magnetic encoder

(75) Inventor: Hideo Mizuta, Okayama (JP)

Correspondence Address: BACON & THOMAS, PLLC, 625 SLATERS LANE, FOURTH FLOOR, ALEXANDRIA, VA, 22314, US

(73) Assignee: UCHIYAMA MANUFACTURING CORP., Okayma (JP)

(21) Appl. No.: 11/724,181

(22) Filed: Mar. 15, 2007

Related U.S. Application Data
(62) Division of application No. 10/850,108, filed on May 21, 2004.

(30) Foreign Application Priority Data
May 22, 2003 (JP) 2003-144383

(51) Int. Cl. H01H 9/00

(52) U.S. Cl. 335/207

(57) ABSTRACT

A magnetic encoder for use in a vehicle axle for generating pulse code by magnetic force. A magnetic ring is attached with an adhesive to a reinforcing ring fixed on the vehicle axle and then S and N poles are alternately magnetized thereon in a circumferential manner. Further the edge of the reinforcing ring is folded to fix the magnetic ring by caulking into the reinforcing ring.

This application is a Divisional of U.S. patent application Ser. No. 10/850,108 which was filed on May 21, 2004.

### FIELD OF THE INVENTION

The present invention relates to a magnetic encoder which has strong magnetic characteristic, superior rigidity and advantage in productivity and cost. More specifically, the present invention relates to a magnetic encoder which is easily attached to a reinforcing ring, and has no fear of generating gap, distortion and deformation resulted from the difference of thermal expansion coefficient between the magnetic ring and the reinforcing ring, and has no fear of damage caused by contamination of foreign material.

### PRIOR ART

A magnetic encoder made of highly elastic rubber material with magnetism has been conventionally used considering damage and deformation caused by contamination of foreign material. The magnetic encoder has been constructed such that a magnetic powder is mixed with the rubber material and the mixture is fed in a mold together with a reinforcing ring and is heated and compressed to be vulcanized and glued.

A magnetic powder of ferrite is generally used for the magnetic powder. Whereas, for example, a magnetic material comprised of rare earth is inferior in kneading working property and moldability and requires high cost, so that it is not suitable to be mixed with a rubber material and it is not generally used.

The magnetic encoder formed by being mixed with the ferrite and vulcanized and glued is superior in moldability, but has small magnetic force and is not uniform in magnetic state density because of orientation of magnetic powder.

The orientation of magnetic powder has to be arranged in advance in the form of dough or to be arranged in process of molding to be vulcanized and molded in order to make the magnetic-flux density uniform (for example, refer to JP-A-2002-333033).

The magnetic encoder made of ferrite bond magnet formed by mixing the magnetic powder of ferrite, as mentioned above, is required to be highly filled with ferrite in order to have practical magnetic characteristic. Therefore, there arise problems such that the rubber property is remarkably deteriorated and its production takes a lots of labor because the above mentioned magnetic encoder is vulcanized and glued in a mold.

Further, complicated site methods are required such that many kinds of ferrite are blended or some extra process of molding are added in order to alleviate the drawback of non-uniform magnetic-flux density of the circumference of the magnetic encoder.

### SUMMARY OF THE INVENTION

The inventors of the present invention have carefully examined and carried out many magnetic characteristic tests. The object of the present invention is to provide a magnetic encoder which has a strong magnetic characteristic, superior handling ability, and possibility in the price.

Still further object of the present invention is to provide a magnetic encoder which is easily fitted to a reinforcing ring even when a magnetic ring is not a unitary magnetic body but is molded by mixing a binder in a magnetic powder and which has no fear of causing gap, distortion, and deformation even when there is the difference of the coefficient of thermal expansion between the magnetic ring and the reinforcing ring and has no fear of damage resulted by contamination of foreign material.

According to one aspect of the present invention, the magnetic encoder, adapted to use for a vehicle axle or the like, for generating pulse code by magnetic force and a magnetic ring is fitted to a reinforcing ring fixed on the vehicle axle with an adhesive and thereafter S and N poles are alternately and circularly magnetized thereon.

Silicone sealant with elasticity may be preferably used as the adhesive for fixing the magnetic ring into the reinforcing ring. Such an adhesive has a cushion ability and absorbs the difference of the coefficient of thermal expansion when the difference between the magnetic ring and the reinforcing ring is large, thereby preventing generation of gap, distortion and deformation.

According to other aspect of the present invention, a magnetic encoder is used for a vehicle axle or the like for generating pulse code by magnetic force and a magnetic ring is fitted to a reinforcing ring fixed on the vehicle axle with an adhesive, then S and N poles are alternately and circularly magnetized thereon, and thereafter the edge of the reinforcing ring is crimped so as to join to the magnetic ring by bending the edge of the reinforcing ring by force.

According to the above-mentioned magnetic encoder, the magnetic ring is fitted to the reinforcing ring by a crimp in place of using the above-mentioned adhesive. Therefore, its production is facilitated while obtaining the same effect of the above-mentioned one aspect of the present invention without using the adhesive.

In both above-mentioned aspects of the present invention, the magnetic ring may be a single magnetic body or a plastic magnet which is formed of a composite substance in which a binder such as rubber or resin is mixed with a magnetic powder such as ferrite. The magnetic ring made of a single magnetic body is easily produced, has high magnetic force, easily produces a magnetic field, has enough strength, and is highly superior in its handling. Therefore, a magnetic encoder with large pulse generation ability can be provided at a low price and its strong magnetic force makes the gap between the magnetic encoder and a sensor larger, so that its assembly tolerance is roughly determined. As a result, the magnetic encoder will be made smaller and more compact and its high productivity and low cost can be achieved.

The thickness and shape of the magnetic ring formed with a magnetic powder such as ferrite are optionally determined, thereby obtaining a lightweight magnetic encoder.

According to other aspect of the present invention, a magnetic ring is covered with a protective cover made of a nonmagnetic material and the protective cover is fitted to the reinforcing ring by crimping or is fixedly engaged so as to join each other. Therefore, without using an adhesive and without giving the magnetic affect on the magnetic sensor, the magnetic ring is protected from being contact with external factor or colliding.

According to other aspect of the present invention, a cushion material is contained between the magnetic ring and the protective cover. Even when improvident pressure is applied or foreign material is bit in case of assembling, the cushion material also functions as a buffer for absorbing shock or impact.

### BRIEF DESCRIPTION OF THE DRAWINGS

FIG. 1 is a sectional view showing one embodiment of a magnetic encoder of the present invention.

FIG. 2 is a sectional view showing other embodiment of a magnetic encoder of the present invention.

FIG. 3 is a sectional view showing other embodiment of a magnetic encoder of the present invention.

FIG. 4 is a diagrammatically sectional view showing the enter construction of a bearing unit incorporating a sealing unit attached with the magnetic encoder of the present invention (FIG. 1).

FIG. 5 is a sectional view of the essential part showing other embodiment of the sealing unit attached with the magnetic encoder of the present invention (FIG. 2).

FIG. 6 is a sectional view of the essential part showing other embodiment of the sealing unit attached with the magnetic encoder of the present invention (FIG. 3).

FIG. 7 is a sectional view of the essential part showing other embodiment of the sealing unit attached with the magnetic encoder of the present invention.

FIG. 8 is a sectional view of the essential part showing other embodiment of the sealing unit attached with the magnetic encoder of the present invention.

### DETAILED DESCRIPTION OF THE INVENTION

According to the present invention, a magnetic ring is comprised of a single magnetic body or is molded by mixing a binder such as rubber or resin into a magnetic powder such as ferrite. The former one can provide a magnetic encoder with large pulse generation ability and with enough strength at a low cost. Cast magnet or sintered magnet is selected as the single magnetic body and ferrite, rare earth, MK steel or alnico is used as the material thereof.

According to a preferable embodiment of such a magnetic encoder, a magnetic ring is directly attached to a reinforcing ring with an adhesive to form a magnetic encoder, so that small and compact magnetic encoder can be obtained because of its high magnetic force, thereby remarkably improving the measurement accuracy.

In either case, the magnetic ring is formed such that the single magnetic body or the molded one by mixing a binder in a magnetic powder is attached to the reinforcing ring with an adhesive and S pole and N pole are magnetized. Unevenness or accidental error is not caused in the output accuracy of magnetic pulse signal even when the magnetic ring is out of alignment of the reinforcing ring.

Now, the embodiments of a magnetic encoder of the present invention are explained referring to the attached drawings.

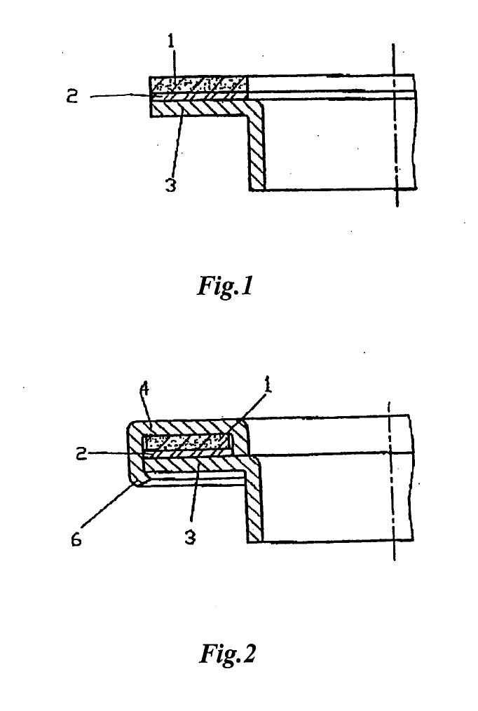

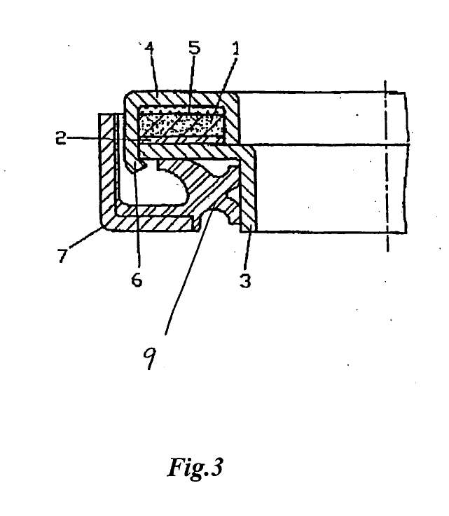

FIG. 1 is a sectional view showing one embodiment of a magnetic encoder of the present invention. FIG. 2 is a sectional view showing an embodiment with a protect cover. FIG. 3 is a sectional view showing an embodiment in which a magnetic encoder is incorporated into a sealing unit.

According to the present invention, a magnetic ring 1 is applied with an adhesive 2 such as cyano, epoxy, phenol, rubber, or polyurethane system and is fixed and integrated with a reinforcing ring 3, thus forming a magnetic encoder. If silicone sealant is used as the adhesive 2, it prevents generation of gap, distortion, and deformation, and functions further as a buffer material.

When a plate made of a magnetic material such as cold-rolled steel (SPCC) and SUS430 is used for the reinforcing ring [[2]] 3 supporting the magnetic ring 1, the magnetic field is enlarged to increase the magnetic force.

If a tarnishable material such as neodymium, steel, boron/samarium or nitrogen is used for the magnetic ring 1, it is better to provide a coating or galvanizing treatment on its surface. Or the magnetic ring 1 is covered with a protective cover 4 made of a nonmagnetic material (aluminum, plastic, nonmagnetic austenitic stainless steel like SUS304, SUS301) in order to protect against scattering moisture and foreign material, as shown in FIG. 2.

FIG. 2 shows an embodiment with the protective cover 4.

The protect cover 4 is fitted to the magnetic ring by crimping 6 in a manner that the extending edge of the cover is bent to join together as shown in FIG. 2, or is fixedly engaged into the corresponding engaging part provided on both members (not shown). When a cushioning material 5 is provided therebetween in order to provide protection from the external stress of the magnetic ring 1 as shown in FIG. 3, a buffering function is expected in case of biting a foreign material in addition to the case of applying pressure under assembly.

Soft material such as rubber, plastic, cloth, nonwoven fabric, paper may be used as the cushioning material 5.

In the embodiment of FIG. 1 and FIG. 2, a magnetic encoder is used as a single body, however it may be used as a part of a blocking or burring material to be incorporated into a sealing unit (described later) in combination with other fixing material 7 which is relatively rotated.

A preferable embodiment which is incorporated into a sealing unit is explained.

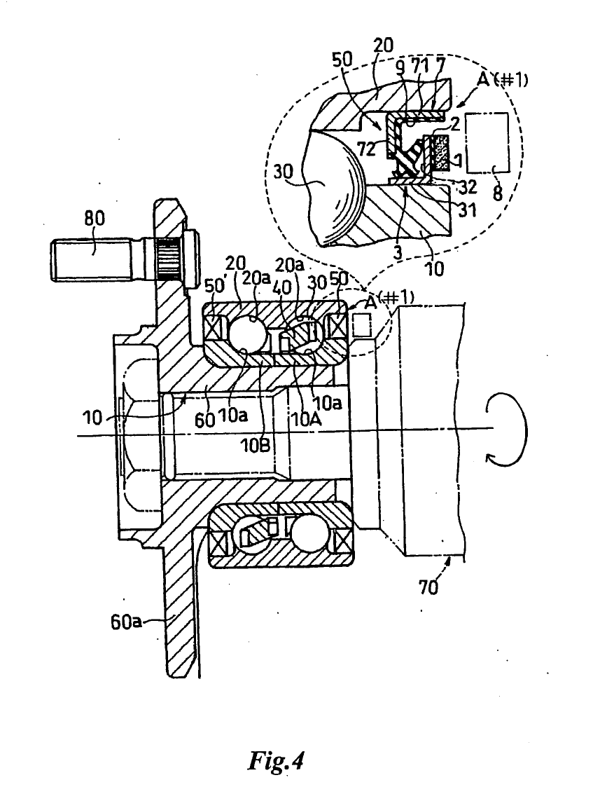

FIG. 4-FIG. 6 show embodiments in which the sealing unit is applied to a bearing unit of a vehicle axle.

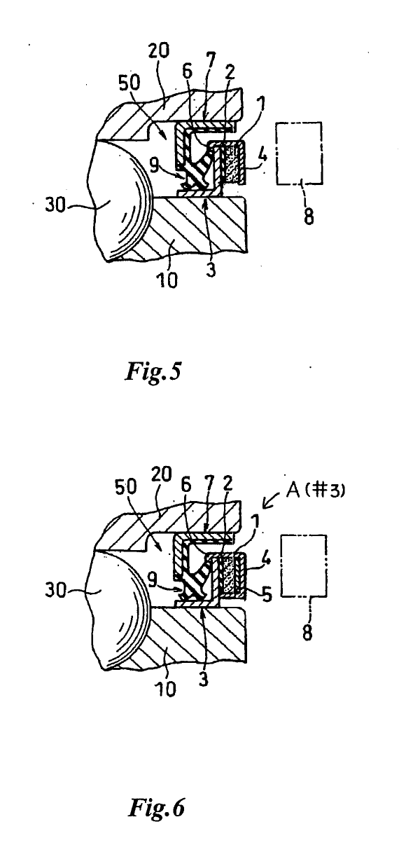

FIG. 4 is a diagrammatically sectional view showing the entire construction of the bearing unit incorporating the sealing unit attached with the magnetic encoder A(#1) shown in FIG. 1. FIG. 5 is a sectional view of the essential part of the sealing unit attached with the magnetic encoder A(#2) shown in FIG. 2. FIG. 6 is a sectional view of the essential part of the sealing unit attached with the magnetic encoder A(#3) shown in FIG. 3. These magnetic encoders A(#1)-A(#3) are not limited to a single magnetic body and may be molded with a magnetic powder mixed with a binder.

The vehicle axle has an inner member 10, an outer member 20, a rolling element 30 housed between the inner member 10 and the outer member 20, and a pair of sealing units 50 and 50′ for sealing the annular end space between the inner member 10 and the outer member 20. The magnetic encoder A(#1) of the present invention (mentioned later) is attached to the sealing unit 50. A magnetic sensor 8 is provided so as to face the magnetic ring 1 of the magnetic encoder A(#1) as shown in FIG. 4, so that a rotary encoder for detecting the wheel rotation speed is constituted.

The inner member 10 and the outer member 20 of the bearing unit have orbit surfaces 10a and 20a of the rolling element 30 respectively and each surfaces are formed like a groove.

The inner member 10 and the outer member 20 are an inner circumferential member and an outer circumferential member via the rolling element 30 respectively and they are rotatable with each other. However, they may be single one like a bearing shaft washer or a bearing housing washer, or may be a combination of a bearing shaft washer or a bearing housing washer with other member.

The inner member 10 may be an axle and the rolling element 30 may be a ball or a roller. In this embodiment a ball is used.

The wheel axle is constructed as an antifriction bearing with double row, more specifically an angular ball bearing with row. The bearing shaft washer is comprised of a pair of dividable shaft washers 10A and 10B which are formed with the orbit surfaces 10a and 10a of the rolling element row respectively. The shaft washers 10A and 10B are fitted in the external circumference of the axle of a hub wheel 60 to constitutes the inner member 10.

The inner member 10 may be comprised of two members, namely a hub wheel with an orbit surface formed by integrating the hub wheel 60 and one shaft washer 10B and other shaft washer 10A, in spite of comprised of three members, namely the hub wheel 60 and a pair of dividable shaft washers 10A and 10B.

One end (for example a housing washer) of an universal joint with uniform velocity 70 is connected to the hub wheel 60 and a vehicle wheel (not shown) is attached to a flange 60a of the hub wheel 60 with a bolt.

The reference numeral 70 indicates an universal joint with uniform velocity and its other end (for example a shaft washer) is connected to a driving wheel (not shown). The outer member 20 is comprised of a bearing housing washer and is attached to a housing (not shown) comprised of a knuckle of a suspension. The rolling element 30 is supported by a retainer 40 per each row.

The magnetic encoder A(#1) of the present invention is provided for one sealing unit 50 of thus constructed vehicle wheel to generate pulse code by the magnetic force. The magnetic ring 1 constitutes the magnetic encoder A(#1) together with the reinforcing ring 3 and magnetic poles N and S are alternately formed around its circumference. The magnetic poles N and S are formed in with a predetermined pitch at a pitch diameter (PCD).

The sealing unit 50 has the reinforcing ring 3 and a fixing member 7 attached to the inner member 10 and the outer member 20 respectively. The reinforcing ring 3 and the fixing member 7 are provided so as to oppose each other to form the letter L with cylindrical portions 31, 71 and vertical plates 32, 72 respectively. According to the present invention, the vertical portion 32 of the reinforcing ring 3 is formed outside of the bearing and the magnetic ring 1 is provided via the adhesive 2 at the outside of the plate 32 as a slinger. A sealing member 9 is vulcanized and integrated at the fixing member 7.

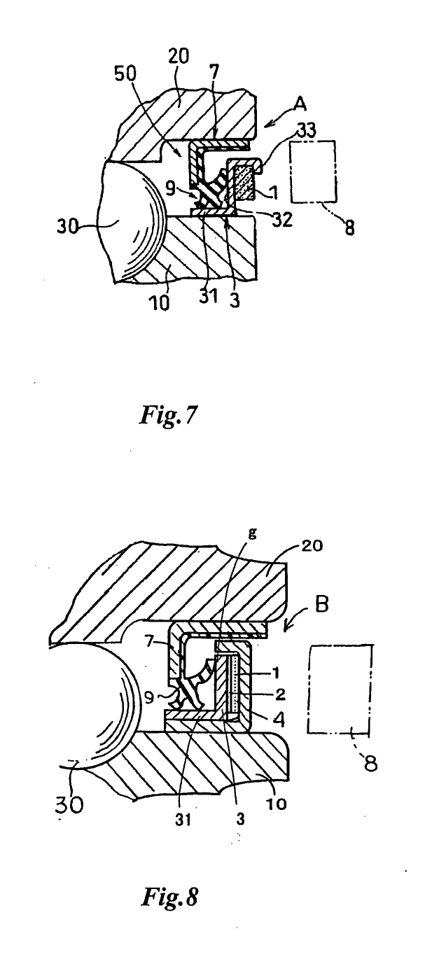

FIG. 7 and FIG. 8 are sectional views of other embodiments of the sealing unit incorporating the magnetic encoders A and B of the present invention respectively.

In these figures, the common members to FIG. 1-FIG. 6 have the same reference numerals and their explanations are omitted here.

The encoder A shown in FIG. 7 is characterized in that the magnetic ring 1 is directly attached to the reinforcing ring 3 by crimping in order not to use the adhesive 2 shown in FIG. 1. More specifically, the edge of the vertical plate 32 of the reinforcing ring 3 is engaged to the magnetic ring 1 and its terminal end is crimped 33. Therefore, the adhesive shown in FIG. 1 is not required and the same effect as the above-mentioned magnetic encoder is achieved.

The magnetic encoder B shown in FIG. 8 is constructed such that the protective cover 4 is fitted to the reinforcing ring 3 fixed to the magnetic ring 1, the fixed one is inserted in the inner member 10 under pressure and the fixing member 7 fixed to the sealing member 9 is inserted under pressure into the outer member 20. In the figure, a gap g is formed between the reinforcing ring 3 and the cover 4 so as not to cause damage for the magnetic ring 1 by contact with each other when the protective cover 4 is fitted in cylindrical portion 31 of the reinforcing ring 3.

According to either one of these magnetic encoders A and B, the magnetic ring 1 is fixed with the reinforcing ring 3 with an adhesive 2 and the magnetic poles S and N are alternately magnetized around its circumference. Therefore, unevenness or accidental error is not caused in the output accuracy of magnetic pulse signal even when the magnetic ring 1 is out of alignment with the reinforcing ring 3. According to these embodiments, a sealant with a cushioning ability is used as an adhesive and a cushioning material is used between the magnetic ring 1 and the protective cover 4, so that even when improvident pressure is applied or foreign material is bit in case of assembling, the cushioning material achieves a buffer action.

1-8. (canceled)

9. A magnetic encoder, adapted to use for a vehicle axle, for generating pulse code by magnetic force, comprising:
a magnetic ring; and
a reinforcing ring, wherein:
said magnetic ring is fitted to said reinforcing ring with an adhesive and thereafter said magnetic ring is magnetized in a manner that the magnetic poles of the same polarity S and N are spaced circumferentially at intervals of a predetermined pitch;
said magnetic ring is covered with a protective cover made of a nonmagnetic material;
said protective cover being fitted to said reinforcing ring by crimping the edge of said protective cover; and
a cushion material is further provided between said magnetic ring and said protective cover.

10. A magnetic encoder, adapted to use for a vehicle axle, for generating pulse code by magnetic force, comprising:
a magnetic ring; and
a reinforcing ring, wherein:
said magnetic ring is fitted to said reinforcing ring with an adhesive and thereafter said magnetic ring is magnetized in a manner that the magnetic poles of the same polarity S and N are spaced circumferentially at intervals of a predetermined pitch; and
said magnetic ring is fitted to said reinforcing ring by crimping the edge of said reinforcing ring.

11. A magnetic encoder, adapted to use for a vehicle axle, for generating pulse code by magnetic force, comprising:
a magnetic ring; and
a reinforcing ring, wherein:
said magnetic ring is fitted to said reinforcing ring with an adhesive and thereafter said magnetic ring is magnetized in a manner that the magnetic poles of the same polarity S and N are spaced circumferentially at intervals of a predetermined pitch;
said magnetic ring is covered with a protective cover made of a nonmagnetic material; and
said protective cover is fixedly engaged to said reinforcing ring.

12. The magnetic encoder according to claim 10, wherein:
said magnetic ring is comprised of a unitary magnetic substance.

13. The magnetic encoder according to claim 10, wherein:
said magnetic ring is made of a composite substance in which a binder such as rubber or resin is mixed with a magnetic powder such as ferrite.

14. The magnetic encoder according to claim 9, wherein:
said magnetic ring is fitted to said reinforcing ring by crimping the edge of said reinforcing ring.

15. The magnetic encoder according to claim 9, wherein:
said magnetic ring is comprised of a unitary magnetic substance.

16. The magnetic encoder according to claim 9, wherein:
said magnetic ring is made of a composite substance in which a binder such as rubber or resin is mixed with a magnetic powder such as ferrite.

17. The magnetic encoder according to claim 9, wherein:
said adhesive is silicone sealant.

18. The magnetic encoder according to claim 10, wherein:
said magnetic ring is further covered with a protective cover made of a nonmagnetic material, and said protective cover is fixedly engaged to said reinforcing ring.

19. The magnetic encoder according to claim 11, wherein:
said magnetic ring is comprised of a unitary magnetic substance.

20. The magnetic encoder according to claim 11, wherein:
said magnetic ring is made of a composite substance in which a binder such as rubber or resin is mixed with a magnetic powder such as ferrite.

21. The magnetic encoder according to claim 11, wherein:
said adhesive is silicone sealant.
